(19) United States
(12) Patent Application Publication
(10) Pub. No.: US 2003/0124412 A1
(43) Pub. Date: Jul. 3, 2003

(54) Fuel-flexible anodes for solid oxide fuel cells

(76) Inventors: Scott A. Barnett, Evanston, IL (US); Jiang Liu, Evanston, IL (US); Brian Madsen, Evanston, IL (US); Zhiqiang Ji, San Jose, CA (US)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/291,875

(22) Filed: Nov. 7, 2002

Related U.S. Application Data
(60) Provisional application No. 60/348,067, filed on Nov. 7, 2001.

(51) Int. Cl. H01M 4/90; H01M 8/12

(52) U.S. Cl. 429/40; 429/13; 429/30

(57) ABSTRACT

The electrochemical oxidation of hydrogen and/or hydrocarbons in solid oxide fuel cells, to generate good power densities at low operating temperatures. Performance is obtained using various ceramic anode components, over a range of useful fuels.

This application claims priority benefit from provisional application serial no. 60/348,067 filed Nov. 7, 2001, the entirety of which is incorporated herein by reference.

### BACKGROUND OF INVENTION

A variety of fuel cells are currently under development. Most utilize hydrogen as fuel, necessitating the use of fuel reforming to convert available hydrocarbon fuels to hydrogen or, in the longer term, an effective hydrogen generation, distribution, and storage infrastructure. Solid oxide fuel cells (SOFCs) are arguably the most fuel-flexible of the various types—they can either internally reform or directly oxidize hydrocarbon fuels—an advantage that has sparked considerable interest. SOFC anodes are usually ceramic-metal (cermet) mixtures. Ni-based cermets, especially Ni-yttria-stabilized zirconia (YSZ), have been used almost exclusively and optimized for hydrogen fuel. Where SOFCs directly utilize hydrocarbon fuels, alternate anode compositions, Ni-ceria or Cu-ceria, are typically used. See, U.S. Pat. No. 6,214,485, the entirety of which is incorporated herein by reference.

However, such anodes are not without some end-use limitations. Ni-cermets with high Ni contents (typically 50 vol %) can promote hydrocarbon cracking; if sufficient coking occurs it generally destroys the anode. A Cu-ceria anode is better suited for heavier hydrocarbons because Cu does not promote coking, but as an electrocatalyst Cu is less effective than Ni—thereby providing relatively low power densities. Furthermore, Cu is a relatively low melting point metal, not compatible with many standard high-temperature SOFC fabrication techniques.

### BRIEF DESCRIPTION OF THE DRAWINGS

FIG. 1. Performance comparison of identical SOFCs with LSCM-GDC-Ni and Ni-GDC anodes in air and H₂ at 750° C.

FIG. 2. Performance of SOFCs with LSCM-GDC-Ni and Ni-GDC anodes operated in air and C₃H₈ at 750° C.

FIG. 3. SEM/EDX scans of LSCM-GDC-Ni anodes after cell testing in humidified propane for 200 mins at 750° C. under (a) short circuit conditions and (b) open circuit conditions.

FIG. 4a. The characteristics of the fuel cell LSCM-Ni-GDC/GDC/LSCF-GDC in CH₄ compared with H₂.

FIG. 4b. The performance of a LSCM-GDC(without Ni)/GDC/LSCF-GDC fuel cell in CH₄ at 750° C.

FIG. 5. Performance of SOFCs with Ni-free and Ni-containing anodes in air and propane.

FIG. 6. Performance of the redoxed fuel cell in H₂.

FIG. 7. Performance of the fuel cell in H₂ prior to redox cycling.

FIG. 8. Performance of the redoxed fuel cell in propane at 750° C. compared with the non-redoxed fuel cell (Cell IV).

FIG. 9. Comparative SOFC performance: C₄H₁₀ and H₂.

FIG. 10. Voltage and power density versus current density for a LSCV-GDC-Ni/GDC/LSCF-GDC cell operated with hydrogen fuel at different flow rates.

FIG. 11. Voltage and power density versus current density for a LSCV-GDC-Ni/GDC/LSCF-GDC cell operated with different dilutions of hydrogen.

FIG. 12. Voltage and power density versus current density for a LSCV-GDC-Ni/GDC/LSCF-GDC cell operated with various fuels.

FIG. 13. Performance of the LSCV-GDC-Ni anode SOFC in hydrogen fuel for different temperatures.

FIG. 14. Impedance spectra from the LSCV-GDC-Ni anode SOFC in hydrogen fuel for different temperatures.

FIG. 15. Performance of the LSCV-GDC-Ni anode SOFC in propane fuel for different temperatures.

FIG. 16. Impedance spectra from the LSCV-GDC-Ni anode SOFC in propane fuel for different temperatures. The rather large amount of noise in the impedance data is not understood at present, but may be associated with the mixed conductivity of the GDC electrolytes.

FIG. 17. Cell current at 500 mV as a function of time during cycling of the fuel gas between hydrogen and air.

FIG. 18. Cell voltage at 80 mA as a function of time during cycling of the fuel gas between propane and air.

FIG. 19. Performance of the SYT/GDC/Ni anode SOFC in hydrogen fuel for different temperatures and over time.

### SUMMARY OF INVENTION

In light of the foregoing, it is an object of the present invention to provide an SOFC anode component, composite and/or component material for production thereof, thereby overcoming various deficiencies and shortcomings of the prior art, including those outlined above. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It is an object of the present invention to provide material composites which can be used under current processing techniques to fabricate SOFC anodes.

It can also be an object of the present invention to provide an anode component and/or material composite useful therewith having a reduced metal catalyst content to decrease or eliminate hydrocarbon cracking and subsequent coking, such reductions as may be relative to Ni-YSZ (˜50 vol %) anodes of the prior art.

It can also be an object of the present invention to provide an SOFC anode incorporating a metal catalytic material and which can be used without substantial carbon deposition.

It can also be an object of the present invention to provide a composite having electronic and ionic conducting phases that are stable and do not exhibit large volume changes upon repeated, alternating reduction and oxidation conditions such that anode components prepared therefrom are less susceptible to degradation upon such redox cycling.

It can also be an object of the present invention to provide a composite which can be materially and/or compositionally altered to optimize the electrocatalytic properties of a specific anode structure designed therefrom. As a corollary thereto, it can also be an object of this invention to provide an anode composite or combination of component materials to optimize the performance properties of a particular fuel cell, depending at least in part upon choice of fuel used therewith.

It can also be an object of the present invention, in combination with one or more of the preceding objectives, to provide a fuel cell and/or anode component thereof useful with a wide range of fuels, including hydrocarbon or corresponding alcohol fuels.

Other objects, features, benefits and advantages of the present invention will be apparent from this summary and its descriptions of various preferred embodiments, and will be readily apparent to those skilled in the art having knowledge of various SOFC devices and assembly/production techniques. Other objects, features, benefits and advantages will be apparent from the above as taken into conjunction with the accompanying examples, data, figures and all reasonable inferences to be drawn therefrom.

The present invention includes various embodiments of a new SOFC anode, one of which where a metallic component content is reduced and in part substituted with an electronically-conducting ceramic. With an oxide as an electronic conductor, the amount of metal catalyst can be lowered to reduce or eliminate coking. Inclusion of an ionically-conducting ceramic, that does not cause coking, may be used to complete a three-phase (or two-phase, non-metal) composite neither suggested nor utilized previously for SOFC electrodes. Most prior work has been focused on two-phase metallic/metal oxide or two-phase metal-oxide combinations, primarily with hydrogen and less so with methane or alcohol fuels. Alternative anodes composed of a single electronically-conducting oxide phase have been employed, but without substantial success. The discussion provided below shows why such attempts were not successful, and may be used to illustrate the enhanced performance available through use of an electronically-conducting ceramic material, as well as the addition of an ionically-conducting and/or catalyst phases. In particular, the new two- or three-phase composites/anodes of this invention using hydrogen fuel perform comparably with Ni-based structures, but operate over a much wider range of fuels, including, but not limited to, natural gas, C₁-C₈ hydrocarbons and the corresponding alcohols. Anodes of such composites or component materials are substantially unaffected, relative to the prior art, by cyclic oxidation and reduction, and are readily processed using standard techniques—both important advantages for a useful, practical fuel cell technology.

In part, the present invention can include a three-phase anode component or material composite comprising (1) an electronically conducting ceramic phase, composition and/or material component; (2) an ionically conducting ceramic phase, composition and/or material component; and (3) a metallic catalyst phase composition and/or material component. In preferred embodiments, the electronically-conducting ceramic phase comprises a lanthanum chromate composition which can be varied by stoichiometry and the inclusion of one or more dopants. In several such embodiments, such a composition or phase can be doped with Sr and/or Mn, but other dopants known to those skilled in the art can be incorporated therewith. More generally, however, any electrically-conducting material can be used, the choice of which is limited only by stability in a particular fuel environment and the relative lack or absence of carbon deposition during cell operation. Various other electronically-conducting phases or materials include, but are not limited to compositions based on YCrO₃ and SrTiO₃. Conducting oxides such as doped SnO₂, In₂O₃ and ZnO may also be used providing adequate match of their respective thermal expansion coefficients with electrolyte materials typically used in such SOFC devices.

Regardless, ionically-conducting phases or material components of this invention include ceria compositions also varied by stoichiometry and the presence of one or more dopants. More generally, various electrolytic materials can be used including stabilized zirconias, doped thorias and ionically-conducting perovskite materials such as (La,Sr)(Mg,Ga)O₃. Alternatively, the present invention also contemplates use of various ceramic materials having both electronic and ionic conductivities sufficient for comparable use and results. Likewise, in various embodiments, the catalytic phase or material of this composite may be nickel, but other metallic materials showing SOFC anode and/or hydrocarbon oxidation catalytic activity could be employed herewith, such materials including but not limited to Fe, Co, Pt, Pd, Ru, Rh, Cu and Au.

In part, the present invention can also include a three-phase anode component for a solid oxide fuel cell. In such a system, the anode component can include an electronically conducting component, an ionically conducting component and a metallic catalyst component. In some embodiments, each of the aforementioned components comprises a phase or material corresponding to a composition of the sort described above. As shown below in the following examples, the relative proportions of each phase or component material can be varied during anode fabrication so as to affect and/or improve SOFC performance. Furthermore, the porosity and particle size distribution of each phase/material within a particular component can be modified during processing, as would be understood by those skilled in the art. Such modifications can further impact the electrochemical performance by changing the density and nature of the contact points between the anode phases/components.

Whether in the context of a two-component or a three-component anode, the electronically-conducting phase and/or materials of this invention can comprise a Group IIB chromite composition. Such phase/materials can include but are not limited to lanthanum chromite compositions doped with strontium, manganese and/or vanadium. Generically, several such lanthanum chromite compositions can be represented as (LaSr)(MnCr)O₃ and (LaSr)(CrV)O₃, such compositions as would be understood by those skilled in the art to include the full range of stoichiometries available. Likewise, various other electronically-conducting materials of this invention, while illustrated with respect to one or more stoichiometric relationships, can be extended to include other such compositions providing functional effect consistent with the invention described herein.

Alternatively, the electronically-conducting material components of this invention can be described as comprising a perovskite oxide composition, as would be understood by those skilled in the art made aware of this invention. Without limitation, such compositions include a range of strontium titanates. Such materials are represented but not limited to several of the embodiments disclosed herein. Likewise, other such perovskite oxides, consistent with this invention, can include various other such compositions over a range of stoichiometries useful for purposes of electronic conductivity.

Generally, with respect to a three-component anode or composite material, the metallic catalytic component is present in an amount sufficient to provide or contribute sufficient catalytic effect. In particular, but without limitation, such a catalytic material can include but is not limited to the metals provided, above. Various other catalytic components of this invention include those metal or metallic components known to those skilled in the art as useful for the cracking and/or oxidation of hydrocarbons. More specifically, with respect to two-component anode systems but also applicable to three-component anode systems, such a metal/metallic component can be present in an amount up to about 10% weight percent of the anode component. Alternatively, in several embodiments, such a component can be present from about 1% weight percent to about 5% weight percent or, optionally, up to about 10% weight percent. Functionally, such a catalytic component can be present in an amount sufficient for a desired degree of catalytic effect without adversely affecting cell performance (i.e., measured polarization resistance) or stability over repeated redox cycles (i.e., anode coking, carbon deposits and/or degradation). Various embodiments provided herein, for purposes of illustration, utilize nickel metal, but other such catalytic materials can also be utilized with good effect.

Various aspects of the present invention are demonstrated below in the context of one or more solid oxide fuel cell configurations. Such cells or a battery thereof, as would be understood by those skilled in the art made aware of this invention, can be utilized in conjunction with either hydrogen or a range of hydrocarbon fuels. Such fuels include, without limitation, about C₁, C₂, C₃ and/or C₄ . . . about C₁₀ hydrocarbons and/or alkanes, either alone (e.g., methane or propane) or as provided in the context of various possible combinations or mixtures (e.g., a natural gas composition). More generally, such fuels include those which can be vaporized or dispersed, or have sufficient vapor pressures, under anode compartment temperatures. Other fuels which may be utilized include ethers and alcohols corresponding to such hydrocarbons, such as but not limited to dimethyl and diethyl ether, methanol and ethanol. JP8, a kerosene-type mixture of hydrocarbons may also be used with good effect.

The range of fuels useful with the present invention corresponds advantageously with operational SFOC stack reaction conditions and products. Depending upon operational conditions, hydrogen may be produced by a hydrocarbon reformation reaction such that with respect to a particular cell component hydrogen may comprise a significant fuel component. As demonstrated below, anode components of the present invention are fuel-flexible, as required for practical, efficient SOFC applications.

In part, the present invention also includes a method of using a solid oxide fuel cell and/or an anode of the type described herein for improved cell performance over a range of fuels. Generally, the inventive method includes 1) providing such an anode in conjunction with a SOFC; and 2) introducing a fuel to the cell and/or directly to the anode under useful operation conditions. In some embodiments, such a method is substantially without coking, hydrocarbon reformation and/or carbon deposition. Regardless, as mentioned above, some anode embodiments may include or be provided without a metal catalyst phase. Fuel cells and/or anodes useful in conjunction with this method can be configured as described elsewhere herein or as would be understood by those skilled in the art made aware of this invention, providing for adequate introduction of a suitable fuel. As discussed elsewhere herein, such fuels include, but are not limited to, hydrocarbons such as C₁-C₈ hydrocarbons, alkanes and/or the corresponding alcohols.

In particular, without limitation, the present invention includes a method of using an electronically-conducting ceramic anode to improve or enhance performance of a solid oxide fuel cell, such performance as can be determined by anode polarization resistance. Such a method comprises (1) providing a solid oxide fuel cell with an anode comprising an electronically-conducting ceramic material and providing a polarization resistance less than about 1 Ωcm²; (2) introducing a fuel to the anode; and (3) operating the cell at a temperature less than about 800° C. Such a polarization resistance is significantly lower than values reported in the prior art, achievable at significantly lower, more practical cell operation temperatures. Without limitation, such a method can be effected in conjunction with anode component materials or compositions of the type described herein. Likewise, without limitation, the present invention can comprise a method of using a ceramic anode to improve solid oxide fuel cell stability over repeated oxidation and reduction cycles, such an affect or improvement as can be demonstrated by the lack or relative absence of hydrocarbon cracking or subsequent carbon deposits. Such a method comprises (1) providing a solid oxide fuel cell with an anode comprising an electrically-conducting ceramic material, and a metallic material catalytic for fuel oxidation; and (2) operating the cell with the anode repeatedly exposed to alternating air/ambient and fuel atmospheres. As demonstrated below, in the context of several examples, anode degradation over redox cycling is reduced or minimized, while cell performance is maintained.

Embodiments of this invention may comprise a lanthanum strontium, chromium manganese oxide ceramic composition or material, generally referred to as LSCM, an example of which includes but is not limited to La_{0.8}Sr_{0.2}Cr_{0.8}Mn_{0.2}O_{3-δ} as an electronically-conducting phase or anode component. This oxide is stable at high temperatures in a wide range of gas compositions. Sr and Mn dopants are among additions to LaCrO₃ that may help match thermal expansion coefficient, increase the electronic conductivity, and improve the sinterability. [Vernoux, P., Guindet, J., and Gehain, E., Electrochemical and catalytic properties of doped lanthanum chromite under anodic atmosphere, in Proc. 3^{rd} European Solid Oxide Fuel Cell Forum (ed. Stevens, P.) 237-247 (European Fuel Cell Forum, Switzerland, 1998)]. Other known LaCrO₃ dopants can be used herewith so long as electronic conductivity is maintained. LaSrCrO₃ anodes have been studied previously for use as SOFC anodes with YSZ electrolytes, but have always provided large polarization resistances, and hence small power densities, because such ceramics are relatively poor catalysts for anode electrochemical reactions. In contrast to and as a departure from the prior art, an LSCM electronic conductor can be incorporated with an ionically-conducting oxide material/composition such as, a gadolinium-doped ceria (generally, GDC) an example of which includes but is not limited to Ce_{0.9}Gd_{0.1}O_{0.1}O_{1.95}. As a result, adhesion on GDC electrolytes may be improved, as is electrochemical performance, presumably by increasing the density of triple-phase boundaries. Inclusion of a small amount (from about 1- about 5 wt % in some embodiments) of nanometer-scale Ni illustrates an advantage of the composites and anode components of this invention. The metal catalyst is not required for current collection or structural support. Its composition and amount can be varied to optimize electro-catalytic properties and minimize or eliminate deleterious carbon deposition.

The metallic, electronically conducting and ionically phases or material components provided herein are not intended to limit the scope of this invention either by way of resulting composite, anode structure or fuel cell configuration. Rather, such constituent components are described to illustrate the numerous possible phase combinations available for use with a particular fuel and/or as needed to provide desired fuel cell performance properties. One skilled in the art, having been made aware of this invention, can design, engineer or otherwise select a composite and/or anode which provides the properties desired for a particular fuel cell application.

With respect to the methods, compositions and/or electrode structures of the present invention, the phases and/or components thereof can suitable comprise, consist of or consist essentially of materials such as those described above. Each such phase or material component is compositionally distinguishable, characteristically contrasted and can be practiced in conjunction with the present invention separate and apart from one another. Accordingly, it should be understood that the inventive composites, anodes and/or methods, as illustratively disclosed herein, can be distinguished from the prior art, as well as practiced or utilized in the absence of any one phase, material, component and/or step which may not be disclosed, referenced or included herein, the absence of which may not be specifically disclosed, referenced or included herein. For instance, for use with certain hydrocarbon fuels, it is contemplated that coking might be avoided by not using a metal catalyst. Accordingly, as mentioned above, the present invention would also include a two-phase composite and a corresponding anode structure including ceramic electronic and ionic conductors.

Alternatively, the present invention contemplates end-use scenarios wherein the conductivity of some electronically conductive phases may be problematic under certain conditions, and even further lowered by inclusion of an ionically conducting material. Under such circumstances, the present invention contemplates use of additional current collector anode layers, depending upon the current collection configuration utilized in a particular SOFC stack. Materials useful for this purpose can include lanthanum chromate or other ceramic electronic conductors of the sort described herein, conducting nitrides or carbides or metals such as, but not limited to, copper.

Various cell structures, configurations and/or types are known and available in the art in which the present anodes could be incorporated advantageously. Without limitation, two types of thin electrolyte geometry can be used: cathode supported and anode supported. Anode supported SOFCs with thin YSZ electrolytes and Ni-YSZ anodes are now widely studied and considered to be the best prospect for SOFC commercialization. The present ceramic-based anodes can be used in these cells, as a thin electrolyte may enhance performance, relative to that shown herein, even more. In this situation, the anode is produced as described herein and the electrolyte and cathode can be subsequently deposited. Similarly, cathode-supported cells have been successfully demonstrated, and have the same advantage of the thin electrolyte. In this alternate situation or geometry, a thin electrolyte may be applied to a bulk cathode support, followed by anode application. Yet other geometries include one or several cells of thin electrode and electrolyte layers connected in series by thin layer interconnects, on an electrically-insulating support, such as those embodiments described in application Ser. No. 09/833,209 to be issued as U.S. Pat. No. 6,479,178, the entirety of which is incorporated herein by reference. In any such configuration, a number of electrolytes and cathodes can be used in conjunction with these inventive anodes. Considering electrolytes, YSZ is a useful overall choice, but other electrolytes include but are not limited to Sc-stabilized zirconia, ceria with various dopants, and (La,Sr)(Ga, Mg)O₃ over a range of useful stoichiometries. Typical cathode materials can be based on the LSM or LSCF materials described elsewhere herein or otherwise known in the art.

### EXAMPLE OF THE INVENTION

The following non-limiting examples and data illustrate various aspects and features relating to the composites and/or structures of the present invention, including the design and assembly of anode components having various phase or material compositions depending upon choice of fuel or desired performance properties—such composites and anodes as are available through the methodologies described herein. In comparison with the prior art, the present composites, materials and/or anode components provide results and data which are surprising, unexpected and contrary thereto. While the utility of this invention is illustrated through the use of several anode components and composite phases which can be used therewith, it will be understood by those skilled in the art that comparable results are obtainable with various other material components, compositional stoichiometries, phases and fuels, as are commensurate with the scope of this invention.

In examples 1-7, the anodes were tested in SOFCs with bulk (0.5 mm thick) GDC electrolytes. Bulk electrolyte cells are a simple expedient for rapidly screening new anode materials, but even with the relatively high ionic conductivity of GDC, there is a substantial electrolyte ohmic loss at low temperatures. Dense 15-mm-diameter pellets were produced by pressing commercial GDC powder and sintering at 1500° C. for 6 hrs. LSCM powder was synthesized by the solid state reaction method. La₂O₃ (99.99%), SrCO₃ (99%), Cr₂O₃ (99%), and MnO₂ (99.9%) powders were weighed and mixed with water prior to ball milling for 24 hrs. After drying and grinding, the LSCM (along with nano-sized GDC and NiO powders, in some cases) was mixed with water and polyvinyl alcohol, ground, and then painted on one side of the GDC pellet. For comparison, anodes consisting of 50 wt % Ni and 50 wt % GDC were also prepared using similar processing conditions. After annealing the anodes at 1100° C. for 3 h, the cathodes, consisting of 50 wt % of La_{0.6}Sr_{0.4}Co_{0.2}Fe_{0.8}O_{1-δ} and 50 wt % of GDC, were applied to the other side of the electrolyte pellet. The cathodes were sintered at 900 C. for 3 h. The anodes and cathodes were both about 30 μm thick and 6 mm by 6 mm in area. Other such anode components of this invention can be prepared using similar techniques, or as can be modified in a straight-forward manner by those skilled in the art, without undue experimentation, as needed for a particular material or component composition.

A. Comparison of LSCM-GDC-NI and Ni-GDC Anodes

### Example 1

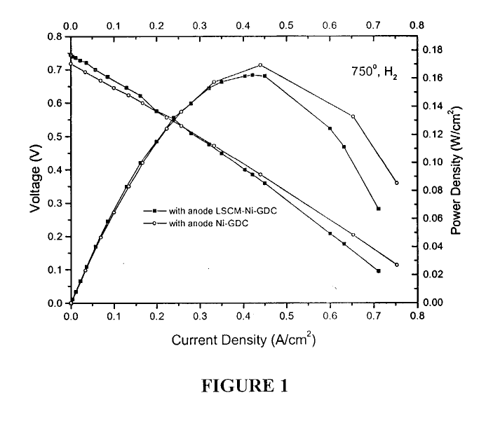

SOFCs were prepared with Ni-GDC and LSCM-GDC-Ni anodes. The SOFCs were tested with air and a few representative fuels: H₂ (typically used in fuel cells), CH₄ (the most common gaseous fuel), C₃H₈ and C₄H₁₀ (common liquid fuels with very high energy densities). FIG. 1 illustrates typical SOFC current-voltage results taken for cells with LSCM-GDC-Ni and Ni-GDC anodes at 750° C. for hydrogen. The performance of the cells with the LSCM-GDC-Ni anodes was similar to the more typical Ni-GDC anodes. In fact, the maximum power density was only a few % less.

### Example 2

Impedance spectroscopy measurements were also carried out during the cell tests, in order to separate the cell resistances arising from the electrolyte and electrodes. The electrolyte ohmic resistance measured at 750° C. was 0.49 Ωcm². This value is in good agreement with the electrolyte ohmic loss expected for 0.5 mm thick GDC. Note that this same value applies for all of the 750° C. results shown below, as the electrolyte composition and thickness was the same in all cases. For the LSCM-GDC-Ni anode cell shown in FIG. 1, the anode plus cathode polarization resistance was 0.44 Ωcm², or 47% of the cell resistance.

### Example 3

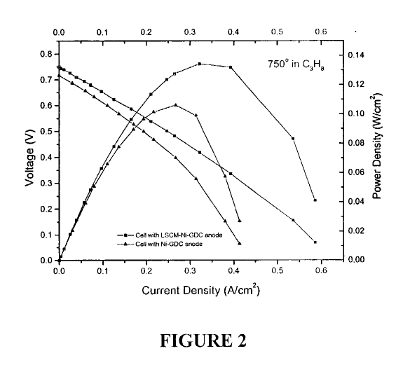

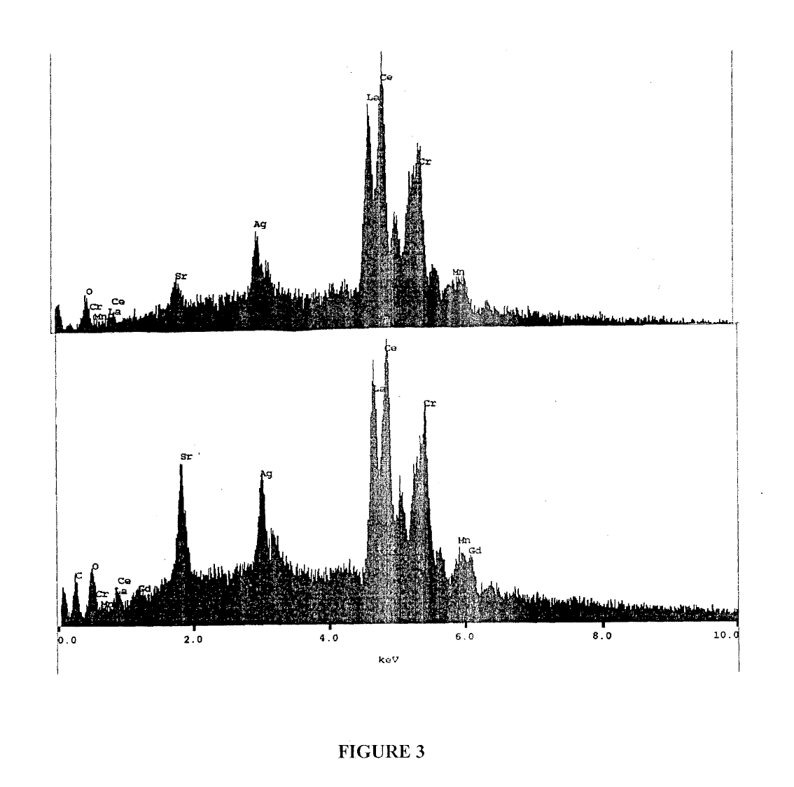

FIG. 2 shows the results for these same cells operated with propane as the fuel. Unlike FIG. 1, the power density with the LSCM-GDC-Ni anodes is actually larger than for Ni-GDC. Furthermore, there was no carbon deposition detected on the ceramic anodes when the cells were operated for several hours at the maximum power point or higher currents. FIG. 3a shows a typical SEM/EDX result indicating no detectable carbon. The same cells maintained at open-circuit condition in propane for >3 hrs showed no visual evidence of carbon deposition, but SEM/EDX revealed a small amount of C (FIG. 3b). It should be noted that LSCM-GDC anodes showed nearly identical SEM/EDX results, indicating that the 5% Ni in the anodes had little influence on carbon deposition. On the other hand, the Ni-GDC anodes showed heavy carbon deposition (gram quantities) after running the cells on propane, even with the cells maintained at short circuit condition. These results indicate that ceramic-based anodes with ≈5 wt % Ni work quite well with heavy hydrocarbon fuels, under conditions where conventional SOFC anodes containing much larger amounts of Ni, i.e. ≈50 wt %, provide lower power and fail rapidly.

B. Effect of Ni in LSCM-GDC Anodes

### Example 4

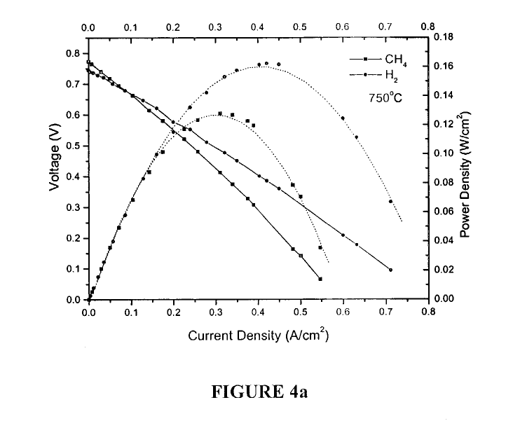

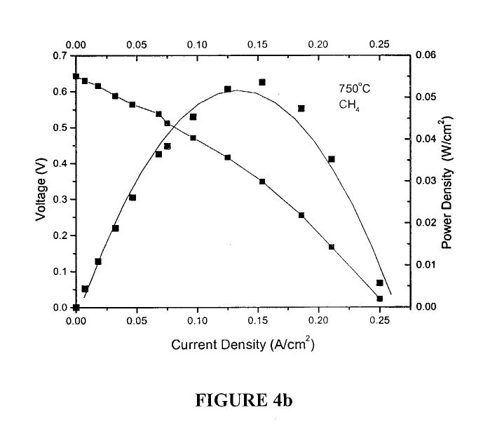

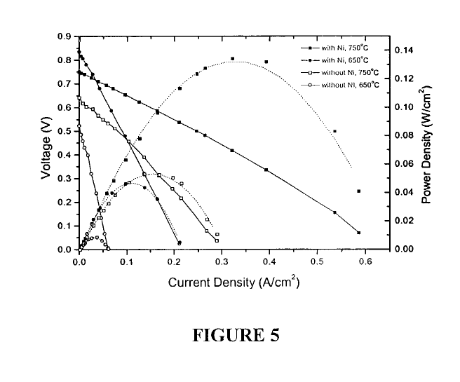

FIG. 4a shows the SOFC characteristics for the aforementioned LSCM-GDC-Ni anode with the methane as the fuel, compared to hydrogen. The performance with methane was not as good as with hydrogen, with an ≈20% lower power density. This is similar to prior reports on SOFCs with Ni-YSZ-Ceria anodes operated on both hydrogen and methane. [Murray, E. P., Tsai, T., Barnett, S. A. A direct-methane fuel cell with a ceria-based anode. Nature 400, 649-651 (1999).] FIG. 4b shows the cell test results obtained when LSCM-GDC (no Ni) was used as the anode with methane as the fuel. In addition to providing a lower current density, the open circuit potential (OCP) was substantially less. As a result, the maximum power density was substantially reduced, from 125 to 50 mW/cm². Additional results comparing anodes with and without Ni tested with propane are shown in FIG. 5. For both temperatures tested, the cells performed much better for the anodes with Ni, providing both higher OCPs and higher current densities.

### Example 5

The above results show the importance of adding a small amount of metal catalyst for obtaining good anode electrochemical performance. This also agrees with prior reports where it was shown that both LaCrO₃ and GDC were relatively poor anode electro-catalysts by themselves. [Primdahl, S., Hansen, J. R., Grahl-Madsen, L., et al. Sr-doped LaCrO3 anode for solid oxide fuel cells. J. Electrochem. Soc. A74-A81 (2001).], [Marina, 0. A., Bagger, C., Primdahl, S., et al. A solid oxide fuel cell with a gadolinia-doped ceria anode: preparation and performance. Solid State Ionics 123, 199-208 (1999).]

C. Effect of Reduction-oxidation Cycling

### Example 6

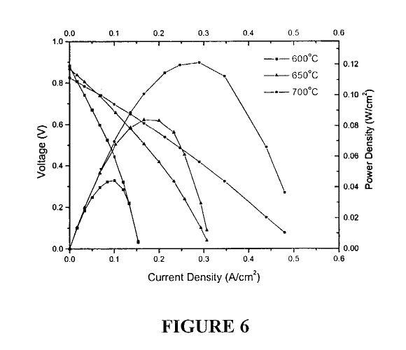

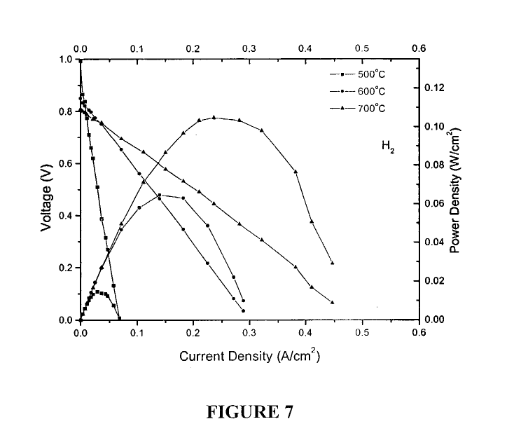

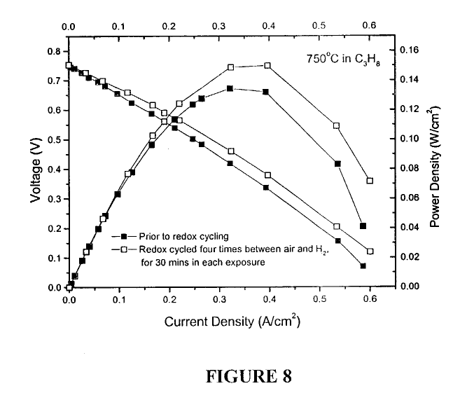

Another important aspect of the new ceramic-based anodes is that they are relatively stable over a range of fuel-gas compositions. It is well known that repeatedly cycling Ni-YSZ anodes between oxidizing and reducing atmospheres has a deleterious effect on their performance, presumably because of the substantial volume change upon oxidation of Ni. [Reitveld, G., Nammensma, P., Ouweltjes, J. P., In Proc. 7^{th} Int. Symp. On Solid Oxide Fuel Cells (Yokokawa, H. and Singhal, S. C.), Electrochem. Soc., p125 (2001).] This is probably because Ni, with a content of ≈50%, is a primary structural component; thus, the large volume changes upon oxidation and reduction may damage the structure. Because of the interest in their stability, the performance of ceramic-based anodes after reduction-oxidation (redox) cycling was investigated. FIG. 6 shows the performance on hydrogen over a range of temperatures for an anode that had been redox cycled four times between air and H₂ (with 3% H₂O), for 30 mins in each exposure, at 750° C. For comparison, the performance of an identical cell prior to redox cycling is shown in FIG. 7. The performance is actually slightly improved after cycling. FIG. 8 shows a comparison of the performance on propane at 750° C. before and after the same redox cycling procedure. As can be seen, the performance is, if anything, increased after cycling. The improvements shown in FIGS. 6-8 may be artifacts, not due to the redox cycling but rather due to slight cell-to-cell variations.

The present anodes may be more stable than Ni-YSZ anodes because the predominant LSCM and GDC phases exhibit only minor volume changes upon reduction and oxidation. While the Ni in these anodes will oxidize and reduce, the amount of Ni is quite small such that little effect on the anode structure is expected.

### Example 7

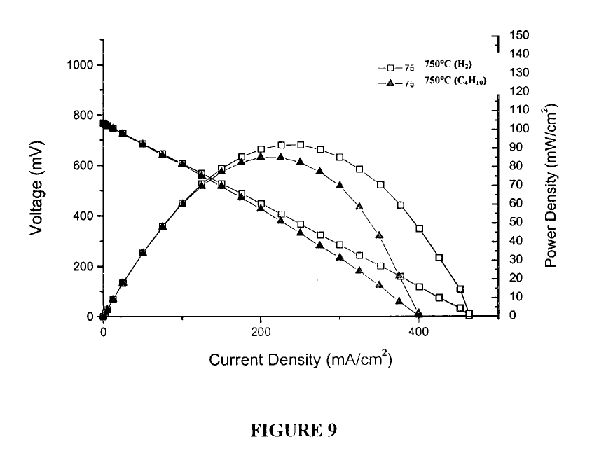

With reference to FIG. 9, SOFC performance was compared with butane and hydrogen fuels. Using anodes structures of the type described herein, the present invention can be employed with higher molecular weight fuels without coking.

In several examples, below, two types of electronically-conducting perovskite oxides illustrate the present invention and use in ceramic anodes: doped LaCrO₃ and doped SrTiO₃. Specifically, La_{0.80}Sr_{0.20}Cr_{0.98}V_{0.02}O_{3-δ} (LSCV) and Sr_{0.88}Y_{0.08}TiO₃ (SYT) were used. Results of the sort provided below show such materials satisfy criteria for a ceramic anode: being stable in a reducing environment, being stable in air for processing, and possessing good conductivity in reducing conditions. They can also demonstrate use of a separate electrochemical catalyst material (e.g. Ni and/or CeO₂). It should be noted also that V added to the present LSCV composition, rather than as a dopant, promotes better sintering.

Stoichiometrically, the LSCV system demonstrated was La_{0.80}Sr_{0.20}Cr_{0.98}V_{0.02}O_{3-δ}. This formulation was explored because it exhibited equally high conductivities as the other LSCV materials studied, despite having lower dopant concentrations, making it less likely to form secondary phases. For example, SrO formation was observed by XRD with higher Sr concentrations. The 2% V content was used because for purposes of improved sintering effect.

Van der Pauw conductivity measurements were carried out on bulk pellets of these oxides in order to verify that they were conducting in typical SOFC fuel conditions (e.g. humidified hydrogen). The LSCV was found to have a conductivity of ≈10 S/cm, in reasonable agreement with prior reports. The SYT had a better conductivity of ≈25 S/cm, again in agreement with prior reports, although it took a long exposure to reducing conditions to obtain the good conductivity.

### Example 8

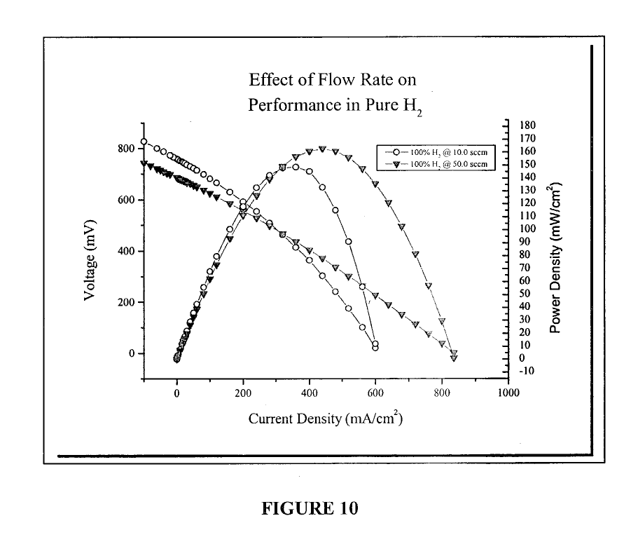

With reference to FIG. 10, performance characteristics were measured for a cell with a LSCV-GDC-Ni anode operated in humidified hydrogen at 750° C. The remainder of the cell consisted of an ≈0.5-mm-thick GDC pellet and a LSCF-GDC cathode, as described above. The power density was ≈0.15 W/cm² for both indicated flow rates, similar to the values observed for LSCM-GDC-Ni anodes (see, example 5 and FIG. 4a). Clearly, the LSCV-based anode was able to effectively utilize hydrogen as a fuel. The two results shown are for different fuel flow rates, corresponding to maximum fuel utilizations of 19% for 10 sccm and 5% for 50 sccm. The steeper slope of the I-V curve at high current for the 10.0 sccm data may be due to depletion of hydrogen and high reaction product content at high fuel utilizations.

### Example 9

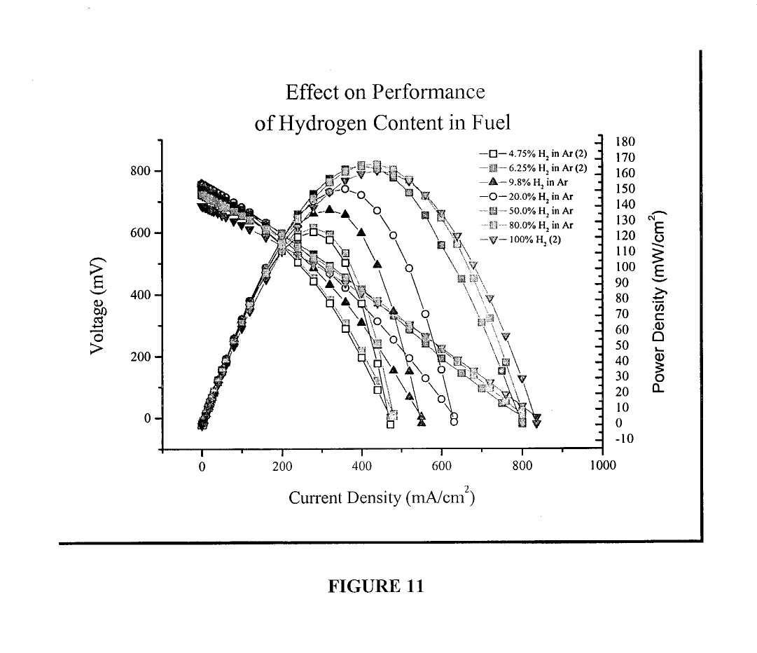

With reference to FIG. 11, the data of this example provides results for mixed H₂/Ar fuels where the fuel flow rate was held constant. Such conditions can simulate fuel depletion to an extent even greater than exhibited above. The OCV varied slightly with fuel composition, reaching a maximum at 10-20% H₂. The maximum current density increased with increasing hydrogen content; this was likely due to the depletion of the hydrogen in the fuel and the production of substantial reaction products. For example, the maximum fuel utilization for the 4.75% H₂ gas was 60%. Overall, the variations in current density and OCV resulted in a maximum power density at 80% H₂.

### Example 10

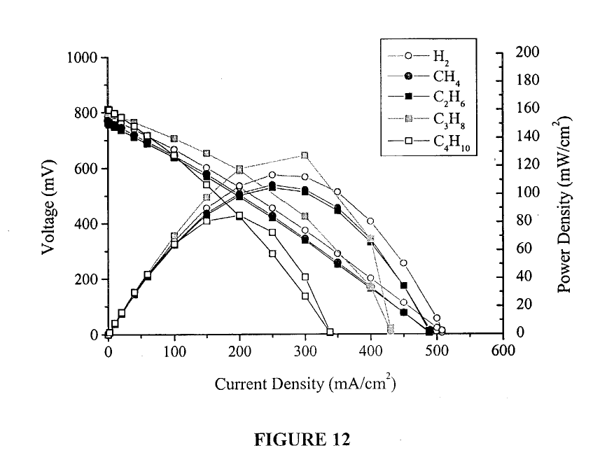

The data of FIG. 12 illustrates the performance of one LSCV-GDC-Ni/GDC/LSCF-GDC cell of this invention (example 8) at 700° C. on hydrogen, methane, ethane, propane, and butane fuels. The performance using all fuels was comparable, with use of propane exhibiting the highest power density and butane the lowest. However, these fuel-to-fuel variations may be due, at least in part, to the slight variation in cell performance over the several days during which the tests were conducted.

### Example 11

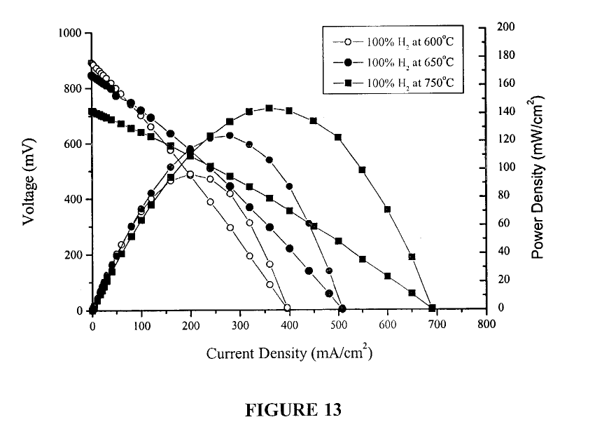

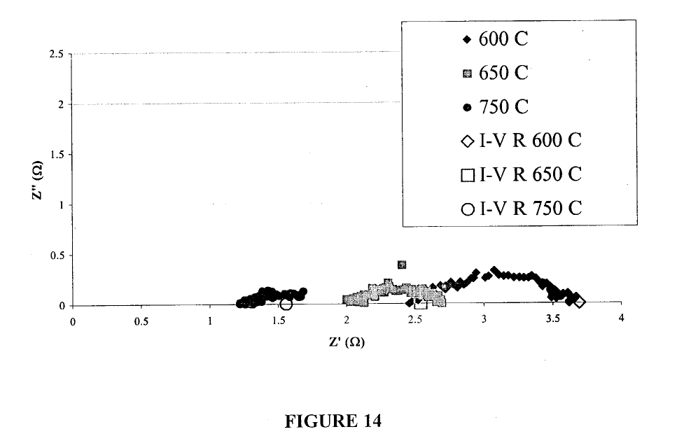

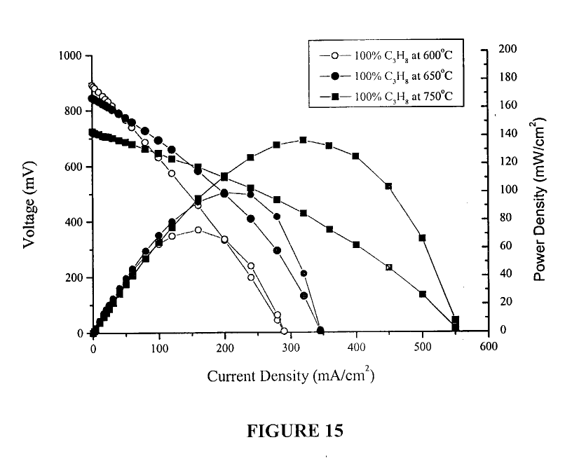

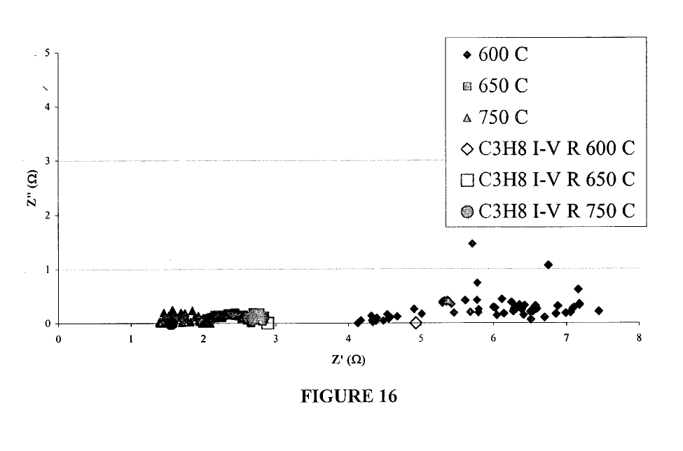

Referring to FIG. 13, operation of a LSCV-GDC-Ni anode based cell with humidified hydrogen fuel, showed cell resistance (as indicated by the slope of the I-V curves in FIG. 13) decreasing with increasing temperature. This is commonly observed in SOFCs and is due to a number of processes that follow Arrhenius temperature dependences. Impedance spectroscopy data (FIG. 14) confirms the decreasing resistance with increasing temperature; the overall resistance values from impedance agree reasonably well with the resistance obtained from the I-V curves in FIG. 13. The impedance results also show that 60-70% of the cell resistance may be due to the thick GDC electrolyte (ohmic loss indicated by the left-most intercept of the impedance arc with the horizontal axis). Similar results were obtained for current-voltage characteristics (FIG. 15) and the impedance data (FIG. 16) with propane fuel, with slightly higher resistance values.

### Example 12

SOFC anodes should have the ability to redox cycle. The prior art Ni-YSZ anodes normally used in SOFCs degrade severely over a few redox cycles. This is a problem for all types of SOFC applications. In large (>100 kW) stationary-power SOFC stacks, shut-down is accomplished by purging the anode compartment with nitrogen. Because of the Ni-YSZ anodes, a sub-system must be included to protect the hot anodes from exposure to air because of an accidental break in stack operation. The problem is more immediate with smaller generators (e.g. for W to kW level applications ranging from portable power to transportation to small-scale distributed-power), where the cells are turned on and off frequently and it is not feasible to include an anode purge system.

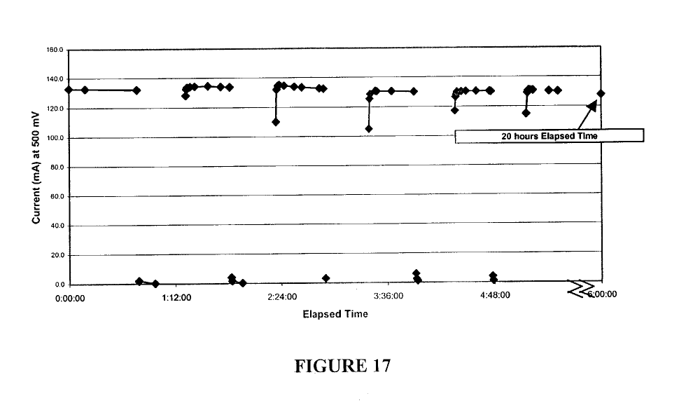

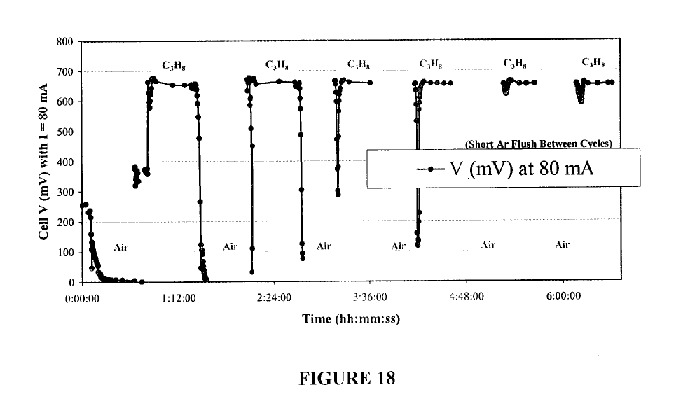

In light of the foregoing considerations, anodes should be stable in both fuel and air. The present ceramic-based anodes can be designed and fabricated to have this capability. FIGS. 17 and 18 show cell performance during a number of repeated redox cycles between alternating air and hydrogen or propane atmospheres, respectively. (Note that Ar purges were used during the propane-air cycles, but only to avoid having an explosive mixture in the gas-feed lines.) In both cases, cell performance returned to its initial level after the redox cycles, demonstrating cell and anode structural stability and/or lack of degradation, as well as one or more other aspects relating to the utility of these anodes.

### Example 13

Cell tests were carried out using an alternate anode component composition, but with a cell geometry as provided above: a GDC electrolyte supported single cell with a thin anode and a thin LSCF cathode. The anode component composition was also as provided above, but for the substitution of another electronically-conducting ceramic of this invention Y-doped SrTiO₃, i.e. (Sr_{0.86}Y_{0.08})TiO₃/GDC/NiO (anode material composition 47.5%, SrYTiO₃,: 47.5% GDC : 0.5% Ni). Various other stoichiometries and/or material weight percentages can be used effectively.

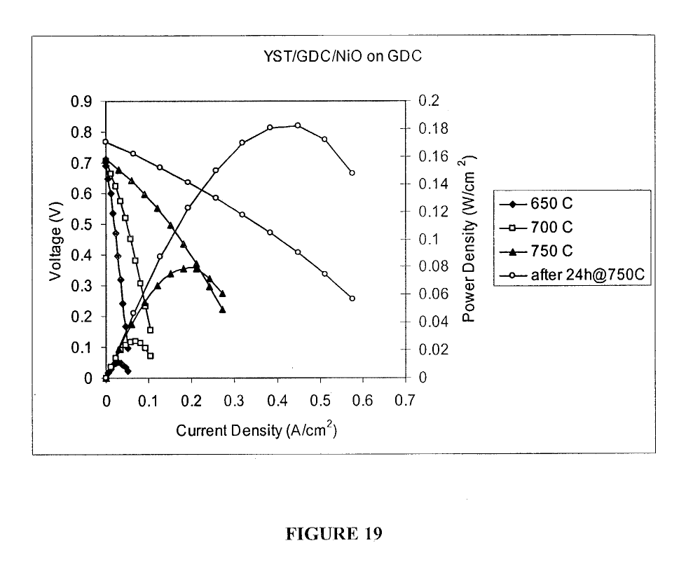

The anode component material mixture was painted on a green GDC pellet and co-sintered at 1450 C. for 6 hours (ramp rate of 3 C./min). Both sintering and adhesion of the anode appeared to be good. A platinum mesh was implanted in the cathode as it was painted on, and then the cathode was sintered at 900 C. for 1 hour. The fuel used for the cell test was hydrogen. The total area of the cell (as defined by the electrode area) was 0.25 cm². Ag paste patterns were painted over the cathode and anode for current collection, and also used to affix the Ag wires used for connection to the testing circuit. The voltage and power density versus current density is shown for three different temperatures (650, 700 and 750° C.) in FIG. 19. The inventive anode provided a current density and a power density that increased dramatically with increasing temperature, achieving a maximum power density of 0.08 W/cm² at 750 C. Cell performance was found to increase over time, with power density doubled after 24 hours, as shown in FIG. 19.

### Example 14

Impedance spectroscopy measurements shown above indicate that the electrolyte resistance represents 60-70% of the total cell resistance; a thin (≈10 μm) electrolyte would reduce or minimize this resistance, in principle allowing current densities and power densities as much as three times higher than shown above. In addition, the low open-circuit voltage of GDC-electrolyte cells may also reduce power density. Accordingly, the present invention can be extended to include use with other electrolytes, including those having thinner dimensions as are available in the art or can be fabricated using known techniques.

In light of the preceding examples, figures and data, comparison can be made with prior art SOFCs. The power densities obtained with the present invention and related cells were similar to those obtained with the Cu-based anodes under similar operating conditions. As mentioned above, the melting points of Cu and Cu₂O are relatively low, limiting processing temperature to unusually low values, and raising questions about the long-term stability of the anodes. In contrast, the present ceramic-based anodes are readily processed at typical SOFC processing temperatures, and are likely stable for long periods. Like Ni-YSZ anodes, Cu-GDC anodes appear susceptible to degradation upon redox cycling because of volume changes. As shown above, the present ceramic anodes appear to be unaffected by cycling.

Doped LaCrO₃ anode materials of the prior art have been considered for use in SOFCs with a yttria-stablized zirconia (YSZ) electrolyte. These anodes, however, yielded relatively high anode polarization resistance at 850° C. operated with hydrogen, 2-5 Ωcm², and the resistance increased gradually with time. The addition of a small amount of Ni yielded a substantial reduction in polarization resistance from 5 to 2 Ωcm². In contrast thereto, the anodes and component materials of this invention show a marked improvement over prior reports, even at a substantially lower temperature (750 versus 850° C.), with a polarization resistance of typically below about 0.5 to about 1.0 Ωcm² (see FIG. 1). The present anodes also gave quite good performance with methane and propane fuels. In further contrast, with methane fuel, prior art LaCrO₃-based anodes showed relatively poor catalytic activity for electrochemical oxidation and reforming reactions with high polarization resistances. Without limitation, such comparisons suggest the results observed, under some conditions or applications, may be attributable to a unique combination of electronically and ionically conducting phases with, optimally, a catalyst material.

Prior art studies of ceria anode performance have also shown in some instances electrochemical methane oxidation without C deposition at 800° C., but yielding low SOFC power densities. However, a recent report has shown poor activity for electrochemical oxidation of methane for ceria when combined with a relatively inert metal current collector, i.e. Au. In other studies where a non-ceramic more catalytically active current collector, e.g. Pt, was used, better performance was achieved with methane but at much higher temperatures, at 800-1015° C. In this regard, the preceding examples and illustrations further support the present invention and distinguish it over the prior art, as may be embodied by use of an ionically-conducting material, such as ceria, and an electronically-conducting component, to construct an effective SOFC anode.

As the previous examples illustrate, good SOFC performance may be obtained over a range of fuels. A relatively small amount of metal catalyst material may, optionally, be used to provide good electrochemical performance, but does not cause coking. This general approach provides great flexibility for improving anode performance by altering the relative amounts and the chemical nature of each of two or three phases. A major advantage of the present anodes is that they can be repeatedly reduced and oxidized without degrading anode stability, structure or performance—redox cycling is expected to occur regularly on periodic shutdown of small generators when the fuel flow is stopped. As such, the SOFC anodes of this invention can be used with new applications of SOFCs that rely on the direct use of high energy density hydrocarbon fuels and feature frequent on-off cycling, such as portable power, auxiliary power units used in transportation, and distributed generation.

While the principles of this invention have been described in connection with specific embodiments, it should be understood clearly that these descriptions, along with the chosen figures, charts, graphics and data presented therein, are made only by way of example and are not intended to limit the scope of this invention, in any manner. For example, the inventive anode and related cell configurations have been shown as utilized with hydrogen or various hydrocarbons; however, as would be well-known to those skilled in the art and made aware of this invention, the articles, devices and methods described herein can also be utilized with various other fuel systems. Likewise, while certain electronically-conducting or ionically-conducting materials have been described herein, others can be used alone or in combination and with and or without various dopants to achieve the same or similar effect. While various parameters, such as temperature and concentrations have been described in conjunction with the construction, fabrication and/or operation of various fuel cells and their anode, cathode and/or electrolyte components, the same parameters can be varied in order to achieve polarization resistances and/or power densities comparable to those described herein.

What is claimed:

1. A solid oxide fuel cell anode component comprising an electronically-conducting ceramic phase, and an ionically-conducting ceramic phase.

2. The anode of claim 1 wherein said electronically-conducting phase comprises a Group IIB chromite composition.

3. The anode of claim 2 wherein said electronically-conducting phase comprises a lanthanum chromite composition doped with at least one of strontium, manganese, vanadium and a combination thereof.

4. The anode of claim 3 wherein said lanthanum chromite composition is selected from (LaSr)(MnCr)O₃ and (LaSr)(CrV)O₃.

5. The anode of claim 1 wherein said electronically-conducting phase is a perovskite oxide.

6. The anode of claim 5 wherein said perovskite oxide is a strontium titanate composition.

7. The anode of claim 6 wherein said titanate composition is doped.

8. The anode of claim 1 wherein said ionically-conducting phase comprises a ceria composition.

9. The anode of claim 8 wherein said ceria composition is doped.

10. The anode of claim 9 wherein said electronically-conducting phase is a lanthanum chromite composition doped with at least one of strontium, manganese, vanadium and a combination thereof.

11. The anode of claim 1 further comprising a phase catalytic for hydrocarbon oxidation.

12. The anode of claim 11 wherein said phase is nickel metal.

13. The anode of claim 12 wherein nickel is present up to about 10 weight percent of said component.

14. The anode of claim 12 wherein said electronically-conducting phase is a lanthanum chromite composition selected from (LaSr)(MnCr)O₃ and (LaSr)(CrV)O₃, and said ionically-conducting phase is a doped ceria composition.

15. The anode of claim 1 configured with a cathode, said configuration comprising a solid oxide fuel cell.

16. The anode of claim 15 wherein said cell configuration provides a battery of cells.

17. An anode component comprising an electronically-conducting ceramic material, an ionically-conducting ceramic material, and a metallic catalytic material.

18. The anode of claim 17 wherein said electronically-conducting ceramic material comprises a lanthanum chromite composition doped with at least one of strontium, manganese, vanadium and a combination thereof.

19. The anode of claim 18 wherein said lanthanum chromite composition is selected from (LaSr)(MnCr)O₃ and (LaSr)(CrV)O₃.

20. The anode of claim 17 wherein said ionically-conducting ceramic material comprises a doped ceria composition.

21. The anode of claim 20 wherein said electronically-conducting material is a lanthanum chromite composition doped with at least one of strontium, manganese, vanadium and a combination thereof.

22. The anode of claim 17 wherein said metallic catalytic material is in an amount sufficient to catalyze fuel oxidation.

23. The anode of claim 22 wherein said catalytic material is nickel metal present up to about 10 weight % of said component.

24. The anode of claim 23 substantially without carbon deposits.

25. The anode of claim 23 wherein said electronically-conducting material is a doped lanthanum chromite composition, and said ionically-conducting material is a doped ceria composition.

26. An anode component comprising an electronically-conducting ceramic material comprising a lanthanum chromite composition doped with at least one of strontium, manganese, vanadium and a combination thereof; and an ionically-conducting ceramic material comprising a ceria composition.

27. The anode of claim 26 wherein said lanthanum chromite composition is selected from (LaSr)(MnCr)O₃ and (LaSr)(CrV)O₃.

28. The anode of claim 27 wherein said ceria composition is doped.

29. The anode of claim 26 further comprising a metallic catalytic material in an amount sufficient to catalyze fuel oxidation.

30. A method of using an electronically-conducting ceramic anode to enhance performance of a solid oxide fuel cell, said method comprising:
providing a solid oxide fuel cell, said cell having an anode comprising an electronically-conducting ceramic material, said anode providing a polarization resistance less than about 1 Ωcm²;
introducing a fuel to said anode; and
operating said cell at a temperature less than about 800° C.

31. The method of claim 30 wherein said electronically-conducting material comprises a Group IIB chromite composition.

32. The method of claim 31 wherein said electronically-conducting ceramic material comprises a lanthanum chromite composition doped with at least one of strontium, manganese, vanadium and a combination thereof.

33. The method of claim 32 wherein said lanthanum chromite composition is selected from (LaSr)(MnCr)O₃ and (LaSr)(CrV)O₃.

34. The method of claim 30 wherein said anode further comprises an ionically-conducting ceramic material.

35. The method of claim 34 wherein said ionically-conducting ceramic material comprises a ceria composition.

36. The method of claim 35 wherein said ceria composition is doped with gadolinium.

37. The method of claim 30 wherein said anode further comprises a metallic material catalytic for fuel oxidation.

38. The method of claim 37 wherein said metallic material is present in an amount greater than about 1.0% weight percent of said anode.

39. The method of claim 37 wherein said metallic material is nickel.

40. The method of claim 39 wherein said operation is substantially without carbon deposition on said anode.

41. The method of claim 37 wherein said anode further comprises an ionically-conducting ceramic material.

42. The method of claim 30 wherein said fuel is selected from hydrogen and a hydrocarbon.

43. A solid oxide fuel cell anode component comprising an electronically-conducting ceramic material and a metallic material catalytic for fuel oxidation, said metallic material present in an amount greater than about 1.0 weight percent of said anode component.

44. The anode of claim 43 wherein said electronically-conducting material comprises a Group IIB chromite composition.

45. The anode of claim 44 wherein said electronically-conducting material comprises a lanthanum chromite composition doped with at least one of strontium, manganese, vanadium and a combination thereof.

46. The anode component of claim 45 wherein said lanthanum chromite composition is selected from (LaSr)(MnCr)O₃ and (LaSr)(CrV)O₃.

47. The anode of claim 43 wherein said metallic material is nickel metal present up to about 10% weight percent.

48. The anode of claim 47 further comprising an ionically-conducting ceramic material.

49. The anode of claim 48 wherein said ionically-conducting material comprises a ceria composition.

50. A method of using a ceramic anode to improve solid oxide fuel cell stability over repeated oxidation and reduction cycles, said method comprising:
providing a solid oxide fuel cell, said cell having an anode comprising an electronically-conducting ceramic material and a metallic material catalytic for fuel oxidation; and
operating said cell with said anode repeatedly exposed to alternating air and fuel atmospheres.

51. The method of claim 50 wherein said metallic material is present in an amount between about 1.0 weight percent of said anode and an amount sufficient for anode degradation over said repeated exposures.

52. The method of claim 51 wherein said metallic material is nickel metal, present between about 1.0 and about 10.0 weight percent.

53. The method of claim 50 wherein said electronically-conducting ceramic material comprises a Group IIB chromite composition.

54. The method of claim 53 wherein said electronically-conducting ceramic material comprises a lanthanum chromite composition doped with at least one of strontium, manganese, vanadium and a combination thereof.

55. The method of claim 50 wherein said anode further comprises an ionically-conducting ceramic material.

56. The method of claim 50 wherein said solid oxide fuel cell is operated using a fuel selected from hydrogen and a hydrocarbon.
